(19) United States
(12) Patent Application Publication
(10) Pub. No.: US 2026/0169873 A1
(43) Pub. Date: Jun. 18, 2026

(54) NODE DEPLOYMENT METHOD AND APPARATUS, AND ELECTRONIC DEVICE

(71) Applicant: Lenovo (Beijing) Limited, Beijing (CN)

(72) Inventors: Dan LI, Beijing (CN); Yankui SUN, Beijing (CN)

(21) Appl. No.: 19/536,148

(22) Filed: Feb. 10, 2026

Related U.S. Application Data
(63) Continuation of application No. PCT/CN2024/098614, filed on Jun. 12, 2024.

(30) Foreign Application Priority Data
Aug. 15, 2023 (CN) 202311029173.1

(51) Int. Cl. G06F 11/20

(52) U.S. Cl. CPC G06F 11/2028; G06F 11/2097

(57) ABSTRACT

A node deployment method includes deploying a first node cluster in a first region, the first node cluster including M first primary nodes, and deploying a second node cluster in a second region, the second node cluster including at least one first secondary node corresponding to the first primary node. Mis a positive integer that ensures that a number of primary nodes in other node clusters meets deployment condition when the first node cluster fails. Meeting the deployment condition includes that the number of primary nodes in the other node clusters is sufficient to determine switching the first primary node to the first secondary node. The first region and the second region are physically separated.

### CROSS-REFERENCE TO RELATED APPLICATIONS

This application is a continuation of International Application No. PCT/CN2024/098614, filed on Jun. 12, 2024, which claims priority to Chinese Application No. 202311029173.1, filed Aug. 15, 2023, the entire contents of both of which are incorporated herein by reference.

### TECHNICAL FIELD

The present disclosure generally relates to the field of data processing technology, and, more particularly, to a node deployment method and apparatus, and electronic device.

### BACKGROUND

Node cluster disaster recovery solution is typically used to ensure data security. The node cluster includes primary nodes and secondary nodes. Ensuring the availability of the node cluster when the primary node fails has become a critical problem that needs to be addressed.

### SUMMARY

In accordance with the disclosure, there is provided a node deployment method including deploying a first node cluster in a first region, the first node cluster including M first primary nodes, and deploying a second node cluster in a second region, the second node cluster including at least one first secondary node corresponding to the first primary node. Mis a positive integer that ensures that a number of primary nodes in other node clusters meets deployment condition when the first node cluster fails. Meeting the deployment condition includes that the number of primary nodes in the other node clusters is sufficient to determine switching the first primary node to the first secondary node. The first region and the second region are physically separated.

Also in accordance with the disclosure, there is provided an electronic device including a memory storing an application program and data generated by execution of the application program, and a processor configured to execute the application program to deploy a first node cluster in a first region, the first node cluster including M first primary nodes, and deploy a second node cluster in a second region, the second node cluster including at least one first secondary node corresponding to the first primary node. M is a positive integer that ensures that a number of primary nodes in other node clusters meets deployment condition when the first node cluster fails. Meeting the deployment condition includes that the number of primary nodes in the other node clusters is sufficient to determine switching the first primary node to the first secondary node. The first region and the second region are physically separated.

Also in accordance with the disclosure, there is provided a non-transitory computer-readable storage medium storing a program that, when executed by a processor, causes an electronic device including the processor to deploy a first node cluster in a first region, the first node cluster including M first primary nodes, and deploy a second node cluster in a second region, the second node cluster including at least one first secondary node corresponding to the first primary node. M is a positive integer that ensures that a number of primary nodes in other node clusters meets deployment condition when the first node cluster fails. Meeting the deployment condition includes that the number of primary nodes in the other node clusters is sufficient to determine switching the first primary node to the first secondary node. The first region and the second region are physically separated.

### BRIEF DESCRIPTION OF THE DRAWINGS

To more clearly illustrate the technical solutions in the embodiments of the present disclosure, the drawings for the description of the embodiments are briefly introduced below. Obviously, the drawings in the following description are merely embodiments of the present disclosure, and those skilled in the art can obtain other drawings based on the present disclosure without creative effort.

FIG. 1 is a schematic flowchart of a node deployment method consistent with the present disclosure.

FIG. 2 schematically shows an application scenario consistent with the present disclosure.

FIG. 3 is a schematic structural diagram of a node deployment apparatus consistent with the present disclosure.

FIG. 4 is a schematic structural diagram of an electronic device consistent with the present disclosure.

### DETAILED DESCRIPTION OF THE EMBODIMENTS

The technical solutions in the embodiments of the present disclosure will be described below with reference to the accompanying drawings. Obviously, the described embodiments are only some embodiments of the present disclosure, not all embodiments. Based on the embodiments of the present disclosure, all other embodiments obtained by those skilled in the art without creative effort are within the scope of the present disclosure.

The terms associated with “first,” “second,” etc., in the specification, claims, and the drawings of the present disclosure are used to distinguish similar objects and do not represent a specific order or sequence. It should be understood that the terms used in this way can be interchanged where appropriate, so that the embodiments of the present disclosure can be implemented in an order other than those illustrated or described herein. Furthermore, the terms “including” and “comprising,” and any variations thereof, are intended to cover non-exclusive inclusion. For example, a process, method, system, product, or apparatus that includes a series of elements not only includes those elements but also includes other elements not explicitly listed, or elements inherent to such a process, method, article, or apparatus.

The present disclosure provides a node deployment method that can be applied in scenarios such as data storage, data disaster recovery, and data processing. Each node is a service (instance) that can perform data storage, indexing, and searching functions. A node cluster can include multiple nodes, which provide resources to the user as a whole. Specifically, a node can be a server, and the corresponding node cluster can be a data center with multiple servers. The node deployment method consistent with the present disclosure effectively guarantees the availability of the node cluster and ensures the reliability of data disaster recovery.

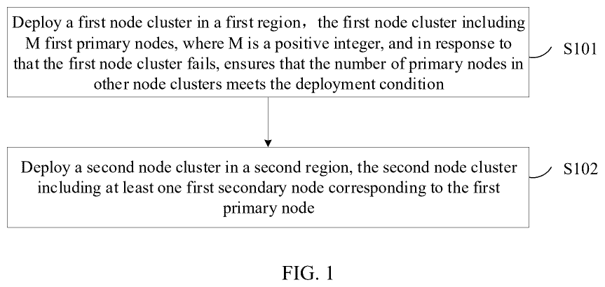

Specifically, FIG. 1 is a flowchart of a node deployment method consistent with the present disclosure, the method includes the following.

At S101, a first node cluster is deployed in a first region.

The first node cluster includes M first primary nodes, where M is a positive integer, and when the first node cluster fails, ensures that the number of primary nodes in other node clusters meets the deployment condition.

At S102, a second node cluster is deployed in a second region.

The second node cluster includes at least one first secondary node corresponding to the first primary node.

The deployment condition indicate that the number of primary nodes in other node clusters is sufficient to determine switching the first primary node to the first secondary node. The first region and the second region are physically isolated.

The present disclosure takes two node clusters as example for illustration, and other node clusters may also be involved, which will be described in subsequent application scenarios. Both the first node cluster and the second node cluster include multiple nodes. In each node cluster, corresponding nodes can be selected as primary nodes and secondary nodes, with the secondary nodes acting as data synchronization nodes for the primary nodes. Taking the first node cluster as an example, a primary database can be deployed on the first primary node, and a secondary database that synchronizes data with the primary database can be deployed on the first secondary node corresponding to the first primary node. This allows the secondary node to synchronize data from the primary node in real time, such that, in the event of a failure of the primary node or a change in service needs, the operations of the primary node can be switched to the corresponding secondary node for execution. In the present disclosure, the secondary node performs real-time data backup of the primary node, thereby achieving data synchronization. Compared to the asynchronous replication of data from the primary node to the secondary node, real-time data backup of primary node by the secondary node better maintains data consistency between the primary node and secondary node, facilitating the switching of the primary node's operation to the secondary node at any time, thus ensuring the effectiveness of the node cluster. The asynchronous replication of data from the primary node to the secondary node includes, but is not limited to, the secondary node completing the replication of primary node data by executing data synchronization instructions issued by the central control area. The asynchronous replication of data from the primary node to the secondary node can also include the secondary node replicating primary node data according to a certain data replication cycle.

Typically, the primary node and secondary node can be deployed in a same node cluster. However, if the entire node cluster fails, the operation switching between these nodes cannot be completed. Therefore, in the embodiments of the present disclosure, at least one first secondary node corresponding to the first primary node in the first node cluster can be deployed in the second node cluster, and the second region where the second node cluster is located is physically isolated from the first region where the first node cluster is located. Physical isolation can be deploying the primary node (first region) and the secondary node (second region) in different data centers in the same city, or in data centers in different cities. This way, even if the entire first node cluster in the first region fails, the secondary node corresponding to the first primary node in the second region can replace the first primary node, ensuring the normal operation of the data. Furthermore, the first node cluster and second node cluster can be deployed in different locations, enabling geographically distributed mutual backup and disaster recovery.

In the embodiments of the present disclosure, the number of primary nodes in each node cluster is a positive integer, and when the node cluster containing the primary node fails, the number of primary nodes in other node clusters meets the deployment conditions. The deployment conditions indicate that the number of primary nodes in other node clusters is sufficient to determine that the primary node of the failed node cluster can be switched to its corresponding secondary node. When a primary node in a node cluster fails, to ensure the normal operation of the primary node, the operation of the primary node needs to be switched to a secondary node. Furthermore, since a primary node usually corresponds to one or more secondary nodes, to determine the optimal secondary node to take over the primary node's operation and avoid frequent node replacements, other primary nodes are used to determine which secondary node the failed primary node's operation can be migrated to. Taking the example of voting through the primary nodes of other node clusters, voting can be voting on the status of a node, or voting on the secondary node to which the primary node's operation will be switched. For example, when the first node cluster fails, the primary nodes of other node clusters can determine the type of failure in the first node cluster through voting. As another example, when the first primary node corresponds to multiple secondary nodes, and the first primary node needs to switch its operation to a secondary node, the primary nodes of other node clusters can determine a target secondary node from among the first primary node's secondary nodes through voting to replace the first primary node. The determination of the voting result can be set according to the specific application scenario. For example, a majority vote can be used to determine the voting result. In the embodiments of the present disclosure, when a node cluster fails, it is ensured that more than half of the primary nodes can vote normally, such as more than half of the primary nodes are functioning normally and vote for the corresponding secondary node, allowing for normal primary-secondary switching, and ensuring that the entire node cluster can operate normally.

It should be noted that using voting to determine which secondary node to which the operations of the failed primary node can be switched to in the embodiments of the present disclosure can determine the status of each node cluster by the primary nodes of other node clusters, allowing for the handling of the failed primary node's current operation and ensuring that the operation of each node cluster is not affected. For example, if the failed primary node is randomly switched to one of its corresponding secondary nodes, it may lead to the secondary node being unable to properly handle the operation of the primary node due to its heavy workload, and also affecting the processing of the secondary node's original operation, such as affecting the secondary node's real-time data synchronization. This could further lead to the unavailability of other node clusters, thus causing widespread failures due to the inability to switch nodes. However, the present disclosure uses voting by the primary nodes of other node clusters to select a node cluster with a better status to take over the operations of the failed node cluster. Correspondingly, based on the voting results, a secondary node with a better status corresponding to the failed primary node can be selected, allowing the secondary node to take over the operations of the primary node and ensuring the availability of the cluster.

Specifically, taking voting as an example, the corresponding voting rules in the deployment conditions can be determined according to different scenario needs. For example, in some scenarios, if at least half of the votes are needed to determine to switch the primary node to a secondary node, then the number of primary nodes M in the first node cluster needs to be less than or equal to one-half of the votes. Correspondingly, if the number of votes needed to determine to switch the first primary node to the first secondary node is at least one-third of the votes, then M needs to be less than or equal to two-thirds of the votes. The present disclosure does not limit on this, as long as the number of deployed primary nodes satisfies the needs that when the first node cluster fails, the number of primary nodes in other node clusters meets the deployment conditions

In the application of node cluster, in some application scenarios, in addition to deploying node clusters, some nodes or apparatus that can perform monitoring, control, or scheduling can also be deployed, such as a central control area, a scheduler, or server monitoring apparatus. However, this deployment method by adding an intermediate apparatus for monitoring the nodes, will increase the power consumption of the entire application scenario or cluster system and reduce operation efficiency. Therefore, the present disclosure provides a method for determining node status without using the aforementioned intermediate apparatus. That is, in the embodiments of the present disclosure, the node status can be automatically determined by the node cluster. For example, whether the primary node meets the current operating needs can be determined by the secondary nodes in the node cluster, and then the primary node and secondary node can be automatically switched. This reduces the power consumption of intermediate devices and improves the efficiency of the node cluster.

Specifically, in some embodiments, the method further includes: if the secondary node corresponding to the first primary node determines that the operation status of the first primary node meets the switching conditions, the operation of the first primary node is switched to the target secondary node corresponding to the first primary node.

The secondary node that monitors the first primary node can be any secondary node corresponding to the first primary node, or a secondary node with optimal performance can be selected as the monitoring node. This secondary node can determine the operation status of the first primary node by monitoring the performance information of the first primary node. The performance information of the first primary node can include one or more of the load information, operation information, or transmission efficiency information of the first primary node. Then, by monitoring the performance information of the first primary node, the secondary node can determined whether the operation status of the first primary node meets the switching conditions. The switching conditions can be determined based on the primary node's performance, services processing capabilities, or the status of the device where the primary node resides. For example, the switching conditions can represent the conditions under which the primary node fails, the conditions under which the services of the first primary node change, or the conditions under which the device where the first primary node is located is under maintenance. That is, when the secondary node corresponding to the first primary node determines that the first primary node has failed, the operations of the first primary node will be switched to the target secondary node corresponding to the first primary node.

Furthermore, the method also includes: if the operation status of the first primary node meets the switching conditions, the secondary node corresponding to the first primary node initiates a vote, with other primary nodes (other than the first primary node) participating in the voting, and based on the voting results, a target secondary node is determined from the secondary nodes corresponding to the first primary node.

After the secondary node initiates the vote, each of the other primary nodes can vote based on the operation status of each secondary node corresponding to the first primary node. Specifically, when a voting request is received, each of the other primary nodes (other than the first primary node) can vote on each secondary node within the voting period and send a voting response message back to the secondary node that initiated the vote. After the secondary node receives the voting response messages from the primary nodes, the voting results are counted. If the secondary node receives more than half of the votes from the primary nodes, the secondary node corresponding to this voting result is determined as the target secondary node, and the operations of the first primary node are switched to the target secondary node. Correspondingly, the target secondary node can also notify all other connected nodes via broadcast that it has replaced the first primary node as the new primary node.

When the target secondary node becomes the primary node, the number of primary nodes in the node cluster where the target secondary node resides will be affected. Taking the determination of the status of other nodes through primary node voting as an example, to ensure that the primary node's vote is effective, the number of primary nodes in the node cluster where the target secondary node resides needs to satisfy that when a failure occurs in that node cluster, the number of other primary nodes meet the deployment conditions. For example, the condition for switching the first primary node to the first secondary node is that the number of votes from primary nodes in the other node cluster needs to be at least one-half of the votes. In this case, M can be a positive integer greater than or equal to 1 and less than or equal to one-half of the total number of primary nodes. For example, when the target secondary node is in the second node cluster, the method of the present disclosure also includes: if, after the switch, the sum of number of second primary nodes and the target secondary node that are in operation is greater than M, the operations of at least one second primary node other than the target secondary node is switched to its corresponding secondary node. Specifically, to ensure the effectiveness of the switch, the operations of another second primary node with a smaller workload can be switched to its corresponding secondary node, or a second primary node whose corresponding secondary node is in a node cluster with fewer primary nodes can be selected as the target second primary node, and the operations of this target second primary node is switched to its corresponding secondary node.

It should be noted that, in order to ensure that the votes of the primary nodes in other node clusters remain valid when a node cluster fails, the number of primary nodes in each node cluster deployed in the embodiments of the present disclosure is a positive integer, and ensures that when the node cluster fails, the number of primary nodes in other node clusters meets the deployment conditions. For example, the second node cluster includes N second primary nodes. N is a positive integer, and ensures that when the second node cluster fails, the number of primary nodes in other node clusters meets the deployment conditions, where meeting the deployment conditions means that the number of primary nodes in other node clusters is sufficient to determine whether to switch the second primary node to the second secondary node corresponding to the second primary node.

In the embodiments of the present disclosure, the number of node clusters can be determined according to actual application needs, that is, it is not limited to the first node cluster and the second node cluster described in the above embodiments, but can also include a third node cluster, a fourth node cluster, etc. Specifically, it can be determined according to actual needs. For example, if the node cluster is applied in a distributed storage scenario, the number of node clusters and the region where the node clusters are to be deployed can be determined based on the amount of data to be stored or the data distribution. In some embodiment, a third node cluster is deployed in a third region, and the third node cluster includes at least the first secondary node corresponding to the first primary node. The third region is physically isolated from the first region, and the third region is physically isolated from the second region.

Correspondingly, when deploying a node cluster in a certain region, the number of nodes deployed in that region can be determined based on the transmission performance of that region to ensure the high efficiency of data transmission on the nodes. Taking the deployment of nodes in the third region as an example, the method also includes deploying a first number of nodes corresponding to the first node cluster in the third region if the transmission delay between the third region and the first region is higher than a threshold. If the transmission delay between the third region and the first region is not higher than the threshold, the method can also include deploying a second number of nodes corresponding to the first node cluster in the third region. The first number is less than the second number.

If the secondary node corresponding to the primary node in the third region is in the first node cluster of the first region, and correspondingly, the secondary node corresponding to the primary node of the first node cluster is in the third node cluster of the third region, when the transmission delay between the third region and the first region is high, and more nodes are deployed in the third region, in the operation of data synchronization between primary node and secondary node, data interaction between primary nodes, or data broadcasting between nodes, more transmission resources are occupied during data transmission between nodes if there are more nodes, for example, more network bandwidth is consumed, which will further cause significant data delays. Therefore, in the embodiments of the present disclosure, the number of nodes deployed in the corresponding region can be determined based on the transmission delay between regions. Specifically, the threshold corresponding to the transmission delay can be determined based on the actual application scenario, for example, the threshold can be 10 ms. The nodes deployed in this region can be secondary nodes of the primary nodes deployed in other regions, and the nodes deployed in this region can also include primary nodes corresponding to other secondary nodes. For example, the first region and the third region can be geographically separated regions. In order to reduce the amount of data transmitted between different locations and avoid more delays, when the transmission delay is high, a less number of nodes corresponding to the first node cluster can be deployed in the third region to reduce the occupation of transmission resources and avoid significant data delays.

The node deployment method provided in the embodiments of the present disclosure can be applied in the field of data disaster recovery, and can also be applied in the field of distributed clusters. In the distributed clusters, the method can be implemented based on ZooKeeper technology, which is a software that provides consistency services for distributed applications. The functions of ZooKeeper include: configuration maintenance, domain name service, distributed synchronization, group services, etc. The method can also be implemented based on a Redis Cluster solution using multiple Redis (Remote Dictionary Server) nodes. For the Redis Cluster solution, data and services can be distributed to multiple primary nodes, and each primary node also has corresponding secondary nodes, which are used to synchronize the data of the primary node.

The node deployment method consistent with the present disclosure will be illustrated below using the Redis Cluster solution as an example. The Redis Cluster represents the node cluster in the embodiments of the present disclosure. In the present disclosure, when a primary node needs to be switched, it is determined by voting by the primary nodes of other node clusters.

The Redis Cluster solution can distribute data and services to multiple primary nodes. However, in the conventional Redis Cluster disaster recovery mechanism, if more than half of the primary nodes in the Redis Cluster fail, even if these primary nodes have secondary nodes, no switching will occur, rendering the cluster unavailable. Therefore, the present disclosure provides a solution for dividing the Redis Cluster into regions and deploying node clusters with a specific number of primary nodes.

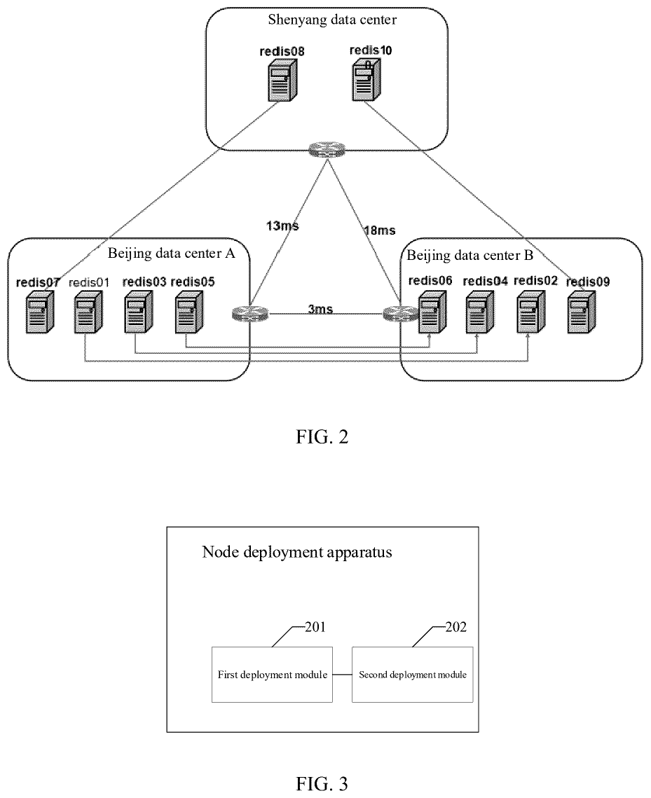

Different geographical locations are used as node deployment regions, with node clusters represented by data centers, and each node in the node cluster represented by a server. FIG. 2 shows an application scenario in the present disclosure. To ensure the availability of the node cluster and to prevent city-wide disasters from paralyzing all servers, the data centers are deployed in different cities in this application scenario. Furthermore, if the city is large, data centers can also be deployed in different areas of the city. For example, if a city experiences a power outage due to natural disasters, and all nodes in the city's data centers are unable to receive and replicate data, this will result in data paralysis. Therefore, in the embodiments of the present disclosure, the secondary nodes corresponding to the primary nodes are deployed in different cities from the city where the primary nodes are located. For example, as shown in FIG. 2, there can be three node clusters (i.e., data centers), including the Shenyang data center, Beijing data center A, and Beijing data center B. Specifically, 5 sets of master-secondary nodes can be deployed according to the scenario needs, forming a 10-node cluster across three data centers. For example, redis08 in the Shenyang data center and redis07 in Beijing data center A are configured as primary and secondary nodes to each other, redis10 in the Shenyang data center and redis09 in Beijing data center B are configured as primary and secondary nodes to each other, redis01 in Beijing data center A and redis02 in Beijing data center B are configured as primary and secondary nodes to each other, redis03 in Beijing data center A and redis04 in Beijing data center B are configured as primary and secondary nodes to each other, and redis05 in Beijing data center A and redis06 in Beijing data center B are configured as primary and secondary nodes to each other.

Furthermore, the transmission delay between Beijing data center A and Beijing data center B is 2-3 ms, the Shenyang data center is a remote data center from Beijing data center A, and the transmission latency between Shenyang data center and Beijing data center A is 13 ms, and the Shenyang data center is a remote data center from Beijing data center B, and the transmission latency between Shenyang data center and Beijing data center B is 18 ms. The Shenyang data center is a remote data center from the Beijing data center, and there is a significant transmission delay between the Shenyang data center and Beijing data center. Therefore, to reduce the amount of data transmitted between different locations and avoid further delays, fewer servers, i.e., fewer Redis instances, can be deployed in the Shenyang data center.

A Redis cluster needs more than half of the votes to function properly. With 5 sets of master-secondary nodes, i.e., 5 primary nodes, at least 3 votes are needed to ensure the validity of the cluster voting. In the present disclosure, a monitoring system can be deployed on the secondary nodes to enable the cluster itself to monitor the status of each node without the need for intermediate devices. For example, when the secondary node corresponding to a primary node detects a failure in the primary node, the secondary node can initiate voting among other primary nodes to determine whether the corresponding secondary node can take over the operations of that primary node. The secondary node can also monitor the number of primary nodes in the cluster after a primary-secondary switch, ensuring that no single data center has more than 3 votes. If a single data center has more than 3 votes, an automatic switch can be performed, switching the corresponding primary node to a secondary node to ensure overall high availability. Taking the Shenyang data center in FIG. 2 as an example, only one node is assigned as a primary node among redis08 and redis10, ensuring that no single data center has more than two primary nodes. If more than two primary nodes are detected in a single date center, the corresponding primary node will be switched to a secondary node, thus ensuring that even if one data center fails, a sufficient number of primary nodes will still participate in the voting, without affecting the overall cluster performance.

The present disclosure also provides a node deployment apparatus, as shown in FIG. 3. The apparatus includes the following.

A first deployment module 201, configured to deploy a first node cluster in a first region. The first node cluster includes M first primary nodes. M is a positive integer, and ensures that when the first node cluster fails, the number of primary nodes in other node clusters meets the deployment conditions.

A second deployment module 202, configured to deploy a second node cluster in a second region, the second node cluster including at least one first secondary node corresponding to the first primary node.

Meeting the deployment conditions means that the number of primary nodes in other node clusters is sufficient to determine whether to switch the first primary node to a first secondary node. The first region and the second region are physically isolated.

In some embodiments, the apparatus further includes the following.

A first switching module, configured to switch the operations of the first primary node to a target secondary node corresponding to the first primary node if the secondary node corresponding to the first primary node determines that the operation status of the first primary node meets the switching conditions.

In some embodiments, the apparatus further includes the following.

A first determination module, configured to initiate a vote by the secondary node corresponding to the first primary node if the operation status of the first primary node meets the switching condition, with voting conducted by other primary nodes besides the first primary node, and based on the voting result, determining a target secondary node among the secondary nodes corresponding to the first primary node.

In some embodiments, the apparatus further includes the following.

A second switching module, configured to switch the operations of at least one other second primary node besides the target secondary node to its corresponding secondary node if, after the switch, the sum of the number of second primary nodes in the operation status and the number of target secondary nodes is greater than M.

In some embodiments, the second node cluster includes N second primary nodes. N is a positive integer, and ensures that when the second node cluster fails, the number of primary nodes in other node clusters meets the deployment conditions. Meeting the deployment conditions means that the number of primary nodes in other node clusters is sufficient to determine whether to switch the second primary node to the second secondary node corresponding to the second primary node.

In some embodiments, the apparatus further includes the following.

A third deployment module, configured to deploy a third node cluster in a third region, the third node cluster including at least the first secondary node corresponding to the first primary node. The third region is physically isolated from the first region, and the third region is physically isolated from the second region.

In some embodiments, the third deployment module includes the following.

A first deployment submodule, configured to deploy a first number of nodes corresponding to the first node cluster in the third region if the transmission delay between the third region and the first region is higher than a threshold.

A second deployment submodule, configured to deploy a second number of nodes corresponding to the first node cluster in the third region if the transmission delay between the third region and the first region is not higher than the threshold.

The first number is less than the second number.

In some embodiments, the apparatus further includes the following.

A database deployment module, configured to deploy a primary database on the first primary node, and deploy a secondary database synchronized with the primary database on the first secondary node corresponding to the first primary node.

It should be noted that that reference can be made to the corresponding content in the foregoing description for the specific implementation of each module and submodule in the present disclosure.

In some embodiments, a readable storage medium is also provided, on which a computer program is stored, and when the computer program is executed by a processor, the computer program implements the node deployment method described in any of the above embodiments.

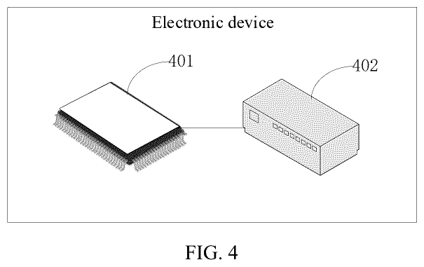

In some embodiments, an electronic device is also provided, as shown in FIG. 4, which includes the following.

A memory 401, configured to store applications and data generated by the execution of the applications.

A processor 402, configured to execute the applications to perform the following method.

Deploy a first node cluster in a first region. The first node cluster includes M first primary nodes. M is a positive integer, and when the first node cluster fails, ensures that the number of primary nodes in other node clusters meets the deployment conditions.

Deploy a second node cluster in a second region, the second node cluster including at least one first secondary node corresponding to the first primary node.

Meeting the deployment conditions means that the number of primary nodes in other node clusters is sufficient to determine whether to switch the first primary node to the first secondary node. The first region and the second region are physically isolated.

In some embodiments, the processor is further configured to execute the applications to perform the following method.

If the secondary node corresponding to the first primary node determines that the operation status of the first primary node meets the switching conditions, switch the operations of the first primary node to the target secondary node corresponding to the first primary node.

In some embodiments, the processor is further configured to execute the applications to perform the following method.

If the operation status of the first primary node meets the switching condition, the secondary node corresponding to the first primary node initiates a vote, with other primary nodes besides the first primary node participate in the voting, the target secondary node is determined among the secondary nodes corresponding to the first primary node based on the voting result.

In some embodiments, the processor is further configured to execute the applications to perform the following method.

If, after the switch, the sum of the number of the second primary nodes in the operation status and the number of the target secondary nodes is greater than M, switch the operations of at least one other second primary node besides the target secondary node to the corresponding secondary node.

In some embodiments, the second node cluster includes N second primary nodes. N is a positive integer, and ensures that when the second node cluster fails, the number of primary nodes in other node clusters meets the deployment conditions. Meeting the deployment conditions means that the number of primary nodes in other node clusters is sufficient to determine whether to switch the second primary node to the second secondary node corresponding to the second primary node.

In some embodiments, the processor is further configured to execute the applications to perform the following method.

Deploy a third node cluster in a third region, the third node cluster including at least one first secondary node corresponding to the first primary node. The third region is physically isolated from the first region, and the third region is physically isolated from the second region.

In some embodiments, the processor is further configured to execute the applications to perform the following method.

If the transmission delay between the third region and the first region is higher than a threshold, deploy a first number of nodes corresponding to the first node cluster in the third region.

If the transmission delay between the third region and the first region is not higher than the threshold, deploy a second number of nodes corresponding to the first node cluster in the third region.

The first number is less than the second number.

In some embodiments, the processor is further configured to execute the applications to perform the following method.

Deploy a primary database on the first primary node, and deploy a secondary database synchronized with the primary database on the first secondary node corresponding to the first primary node.

It should be noted that reference can be made to the corresponding content in the foregoing description for the specific implementation of the processor in the present disclosure.

The various embodiments in this specification are described in a progressive manner, with each embodiment focusing on the differences from other embodiments. Similar parts between the embodiments can be referred to each other. For the devices disclosed in the embodiments, since they correspond to the methods disclosed in the embodiments, the description is relatively simple, and relevant details can be found in the method description.

Those skilled in the art will further appreciate that the units and algorithmic processes of the examples described in the embodiments disclosed herein can be implemented in electronic hardware, computer software, or a combination of both. To clearly illustrate the interchangeability of hardware and software, the components and processes of the examples have been generally described above in terms of their functionality. Whether these functions are implemented in hardware or software depends on the specific application and design constraints of the technical solution. Those skilled in the art may use different methods to implement the described functions for each specific application, but such implementation should not be considered outside the scope of the present disclosure.

The methods or algorithms described in connection with the embodiments of the present disclosure may be directly implanted in hardware, a software module executed by a processor, or a combination of both. A software module may reside in random access memory (RAM), memory, read-only memory (ROM), electrically programmable ROM, electrically erasable programmable ROM, registers, hard disk, removable disk, CD-ROM, or any other form of storage medium known in the art.

The above description of the disclosed embodiments enables those skilled in the art to make or use the present disclosure. Various modifications to these embodiments will be obvious to those skilled in the art, and the general principles defined herein may be implemented in other embodiments without departing from the spirit or scope of the present disclosure. Therefore, the present disclosure will not be limited to the embodiments disclosed herein, but is to be accorded the widest scope consistent with the principles and novel features disclosed herein.

What is claimed is:

1. A node deployment method comprising:
deploying a first node cluster in a first region, the first node cluster including M first primary nodes; and
deploying a second node cluster in a second region, the second node cluster including at least one first secondary node corresponding to the first primary node;
wherein:
M is a positive integer that ensures that a number of primary nodes in other node clusters meets deployment condition when the first node cluster fails;
meeting the deployment condition includes that the number of primary nodes in the other node clusters is sufficient to determine switching the first primary node to the first secondary node; and
the first region and the second region are physically separated.

2. The method according to claim 1, further comprising:
in response to the secondary node corresponding to the first primary node determining that operation status of the first primary node meets the switching condition, switching operations of the first primary node to one or more target secondary nodes corresponding to the first primary node.

3. The method according to claim 2, further comprising:
in response to the operation status of the first primary node meeting the switching condition, the secondary node corresponding to the first primary node initiates a vote in which primary nodes other than the first primary node participate, and determines the one or more target secondary nodes from secondary nodes corresponding to the first primary node based on voting result.

4. The method according to claim 2, further comprising:
in response to, after the switching, a sum of a number of second primary nodes in the operation status and a number of the one or more target secondary nodes being greater than M, switching the operation of at least one second primary node other than the one or more target secondary nodes to a corresponding secondary node.

5. The method according to claim 1, wherein:
the second node cluster includes N second primary nodes;
N is a positive integer that ensures that the number of primary nodes in other node clusters meets the deployment condition when the second node cluster fails; and
meeting the deployment condition includes that the number of primary nodes in other node clusters is sufficient to determine whether to switch the second primary node to a second secondary node corresponding to the second primary node.

6. The method according to claim 1, further comprising:
deploying a third node cluster in a third region, the third node cluster including at least one first secondary node corresponding to the first primary node;
wherein the third region is physically isolated from the first region and the second region.

7. The method according to claim 6, further comprising:
in response to a transmission delay between the third region and the first region being greater than a threshold, deploying a first number of nodes corresponding to the first node cluster in the third region; or
in response to the transmission delay between the third region and the first region being not greater than the threshold, deploying a second number of nodes corresponding to the first node cluster in the third region;
wherein the first number is less than the second number.

8. The method according to claim 1, further comprising:
deploying a primary database on the first primary node; and
deploying a secondary database synchronized with the primary database on the first secondary node corresponding to the first primary node.

9. An electronic device comprising:
a memory storing an application program and data generated by execution of the application program; and
a processor configured to execute the application program to:
deploy a first node cluster in a first region, the first node cluster including M first primary nodes; and
deploy a second node cluster in a second region, the second node cluster including at least one first secondary node corresponding to the first primary node;
wherein:
M is a positive integer that ensures that a number of primary nodes in other node clusters meets deployment condition when the first node cluster fails;
meeting the deployment condition includes that the number of primary nodes in the other node clusters is sufficient to determine switching the first primary node to the first secondary node; and
the first region and the second region are physically separated.

10. The electronic device according to claim 9, wherein the processor is further configured to execute the application program to:
in response to the secondary node corresponding to the first primary node determining that operation status of the first primary node meets the switching condition, switch operations of the first primary node to one or more target secondary nodes corresponding to the first primary node.

11. The electronic device according to claim 10, wherein the processor is further configured to execute the application program to:
in response to the operation status of the first primary node meeting the switching condition, cause the secondary node corresponding to the first primary node to initiate a vote in which primary nodes other than the first primary node participate, and determine the one or more target secondary nodes from secondary nodes corresponding to the first primary node based on voting result.

12. The electronic device according to claim 10, wherein the processor is further configured to execute the application program to:
in response to, after the switching, a sum of a number of second primary nodes in the operation status and a number of the one or more target secondary nodes being greater than M, switch the operation of at least one second primary node other than the one or more target secondary nodes to a corresponding secondary node.

13. The electronic device according to claim 9, wherein:
the second node cluster includes N second primary nodes;
N is a positive integer that ensures that the number of primary nodes in other node clusters meets the deployment condition when the second node cluster fails; and
meeting the deployment condition includes that the number of primary nodes in other node clusters is sufficient to determine whether to switch the second primary node to a second secondary node corresponding to the second primary node.

14. The electronic device according to claim 9, wherein the processor is further configured to execute the application program to:
deploy a third node cluster in a third region, the third node cluster including at least one first secondary node corresponding to the first primary node, the third region being physically isolated from the first region and the second region.

15. The electronic device according to claim 14, wherein the processor is further configured to execute the application program to:
in response to a transmission delay between the third region and the first region being greater than a threshold, deploy a first number of nodes corresponding to the first node cluster in the third region; or
in response to the transmission delay between the third region and the first region being not greater than the threshold, deploy a second number of nodes corresponding to the first node cluster in the third region, the first number being less than the second number.

16. The electronic device according to claim 9, wherein the processor is further configured to execute the application program to:
deploy a primary database on the first primary node; and
deploy a secondary database synchronized with the primary database on the first secondary node corresponding to the first primary node.

17. A non-transitory computer-readable storage medium storing a program that, when executed by a processor, causes an electronic device including the processor to:
deploy a first node cluster in a first region, the first node cluster including M first primary nodes; and
deploy a second node cluster in a second region, the second node cluster including at least one first secondary node corresponding to the first primary node;
wherein:
M is a positive integer that ensures that a number of primary nodes in other node clusters meets deployment condition when the first node cluster fails;
meeting the deployment condition includes that the number of primary nodes in the other node clusters is sufficient to determine switching the first primary node to the first secondary node; and
the first region and the second region are physically separated.

18. The storage medium according to claim 17, wherein the program, when executed by the processor, further causes the electronic device to:
in response to the secondary node corresponding to the first primary node determining that operation status of the first primary node meets the switching condition, switch operations of the first primary node to one or more target secondary nodes corresponding to the first primary node.

19. The storage medium according to claim 18, wherein the program, when executed by the processor, further causes the electronic device to:
in response to the operation status of the first primary node meeting the switching condition, cause the secondary node corresponding to the first primary node to initiate a vote in which primary nodes other than the first primary node participate, and determine the one or more target secondary nodes from secondary nodes corresponding to the first primary node based on voting result.

20. The storage medium according to claim 18, wherein the program, when executed by the processor, further causes the electronic device to:
in response to, after the switching, a sum of a number of second primary nodes in the operation status and a number of the one or more target secondary nodes being greater than M, switch the operation of at least one second primary node other than the one or more target secondary nodes to a corresponding secondary node.
